(19) United States
(12) Patent Application Publication
(10) Pub. No.: US 2014/0131190 A1
(43) Pub. Date: May 15, 2014

(54) PURIFICATION DEVICE FOR PURIFYING AND HEATING DIRTY LIQUID

(71) Applicants: Henri SADOUNE, Muenchen (DE); Yannick DIEUDONNE, Stuttgart-Zuffenhausen (DE)

(72) Inventors: Henri SADOUNE, Muenchen (DE); Yannick DIEUDONNE, Stuttgart-Zuffenhausen (DE)

(21) Appl. No.: 14/081,477

(22) Filed: Nov. 15, 2013

(30) Foreign Application Priority Data
Nov. 15, 2012 (DE) 102012110989.3

(51) Int. Cl. C02F 1/04

(52) U.S. Cl. CPC C02F 1/043
USPC 203/10; 202/232; 202/185.1

(57) ABSTRACT

A purification device for purifying dirty liquid is provided. The device includes a heating vessel for heating the dirty liquid, at least one inlet valve, at least one outlet valve, at least one gas overpressure valve for discharging gas located in the heating chamber, the valves being mechanically engaged with each other via a valve control unit such that in operation of the heating vessel, up to a limit gas pressure, the inlet valve can be operated in an open position and the outlet valve and the gas overpressure valve can be operated in a closed position), and once the limit gas pressure has been exceeded, the inlet valve can be closed by the valve control unit and the outlet valve and/or the gas overpressure valve can be opened by the valve control unit.

### CROSS-REFERENCE TO RELATED APPLICATIONS

This application claims the benefit of German Application No. 102012110989.3 filed Nov. 15, 2013, the contents of which are incorporated herein by reference.

### DESCRIPTION

The invention relates to a purification device for heating and purifying dirty liquid, as well as to a method for producing a clean liquid from a dirty liquid.

The purification device comprises a heating vessel for heating the dirty liquid, at least one inlet valve for feeding the dirty liquid into a heating chamber of the heating vessel, at least one outlet valve for discharging the dirty liquid from the heating vessel and at least one gas overpressure valve for discharging gas located in the heating chamber, in accordance with the preamble of claim 1.

A large number of generic heating and/or purification devices are already known from the prior art. Thereby, the dirty liquid is heated within the heating vessel and as a result is for example made to boil. However, heating which is known according to the prior art has hitherto only been able to be carried out by means of technically complicated electronic triggering of the valves. Such triggering is however prone to failure and expensive in terms of maintenance and acquisition. In particular in more rural areas, for example in the developing world, however, such devices which are known according to the prior art cannot manage without electric power and intensive expert maintenance.

An object to be achieved is to devise a particularly inexpensive and low-maintenance purification device for heating and purifying dirty liquid, in order to avoid the above-mentioned problems.

In order now to devise a purification device for heating and purifying dirty liquid which is particularly inexpensive and low-maintenance, the present invention makes use of the idea, inter alia, of arranging at least one valve control unit for mechanically controlling the valves within the purification device, the inlet valve, the outlet valve and the gas overpressure valve being mechanically engaged with each other via the valve control unit such that in operation of the heating vessel, during heating of the dirty liquid, up to a limit gas pressure which can be pre-set by the valve control unit of at least one atmosphere within the heating chamber, the inlet valve can be operated in an open position and the outlet valve and the gas overpressure valve can be operated in a closed position in each case by the valve control unit. Once the limit gas pressure has been exceeded, the inlet valve can be closed by the valve control unit and the outlet valve and/or the gas overpressure valve can be opened by the valve control unit. If the gas pressure, having exceeded the limit gas pressure, then falls below said limit pressure, the outlet valve and/or the gas overpressure valve can be closed again by the valve control unit and the inlet valve can be opened again.

A valve control unit of this type ensures that during operation of the purification device a gas pressure which is generated and/or located within the heating chamber fluctuates around the pre-settable limit gas pressure. If the gas pressure in the heating chamber increases only slowly, it may be sufficient, in order to reduce the pressure, to open only the gas overpressure valve, while the other two valves remain closed. If however the gas pressure increases rapidly and/or quickly in the heating chamber, the outlet valve can be opened additionally or on its own to relieve the pressure. The opening of the outlet valve therefore brings with it particularly rapid pressure relief, since the density of the dirty water is greater than the density of the gas vapour, and thus a reduction in pressure occurs upon discharging the dirty water more rapidly than when only the gas overpressure valve is opened on its own. Preferably during operation of the purification device the measured gas pressure deviates by less than 10%, preferably by less than 5%, from the limit gas pressure. It is thus ensured that the gas pressure and also the temperature within the heating vessel can be kept as constant as possible. Preferably the temperature in the heating vessel is at least 90° C. and at most 120° C. In particular, the limit gas pressure may be exactly one atmosphere within the heating chamber.

Such a gas pressure within the heating chamber which is as constant as possible is therefore particularly important, since the boiling temperature of a large number of liquids is well-known for example at the limit gas pressure of one atmosphere. For example, water boils at a temperature of about 100° C. at a gas pressure of one atmosphere. The present invention is based in particular on the realisation that dirty water may consist for example of 99% water and 1% dirt, for example organic or inorganic impurities. In the case of dirty water, it may also be for example salt water. In this case, salt is to be regarded as the type of dirt in question.

In such case, the degree of pollution (%) is yielded by the following formula:

$$Degree of pollution ( \% ) = \frac{pollution density [ \frac{mg}{l} ]}{water density [ \frac{mg}{l} ]} \times 100 \qquad$$

Such a degree of pollution of the water of for example 1% therefore suggests freeing the water from such a low degree of pollution, so that dirty water can be made for example drinkable again by the purification device once it has been freed from the dirt. A purification device of this type can therefore contribute decisively to at least alleviating water shortages in arid regions of the earth.

The low degree of pollution therefore results in the boiling properties of the dirty liquid, i.e. for example of the dirty water, being extremely similar to those of for example pure water. This fact therefore directly permits a conclusion that, although the boiling temperature of the dirty liquid, compared with pure water, is not known initially, owing to the low degree of pollution of the dirty liquid the actually unknown boiling temperature is the same, except for insignificant deviations, compared with for example pure water.

In other words, it can be concluded from this that, provided that the gas pressure within the heating chamber is known and is as constant as possible, i.e. for example is one atmosphere, owing to the extremely similar boiling properties of the dirty liquid to those of for example water a conclusion can be drawn directly likewise as to whether the dirty liquid is also already boiling within the heating chamber.

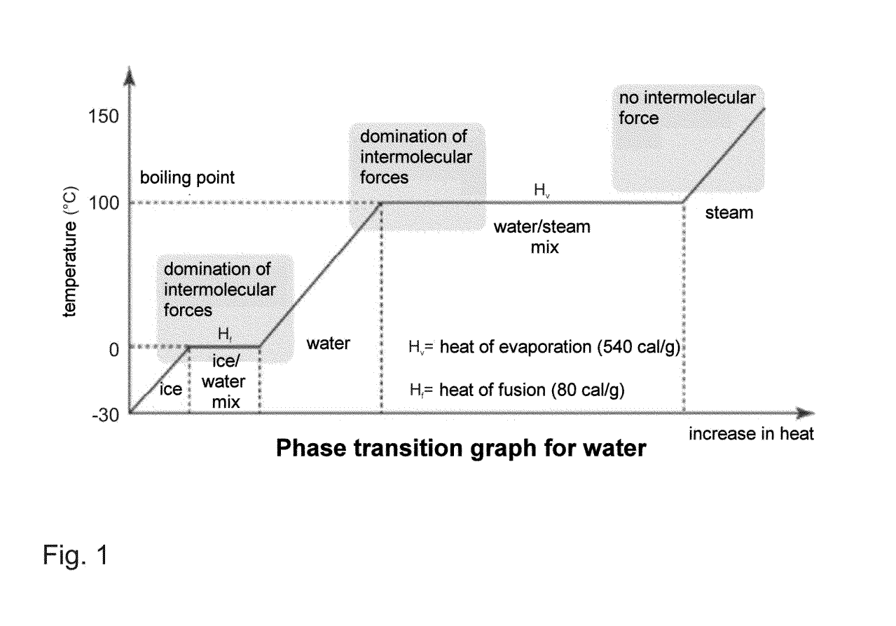

FIG. 1 serves to explain the behaviour of water during heating. It can readily be recognised from this figure that during the boiling process the temperature is constant as long as not all the water has yet evaporated. This fact is decisive for the design of the tank, and in addition it is also one of the reasons why the heating vessel should be operated at a pre-settable limit gas pressure of for example one atmosphere.

According to at least one embodiment, the purification device comprises a heating vessel for heating the dirty liquid. The heating vessel is a hollow body which can absorb the dirty liquid. Preferably the heating vessel is formed from a material which is temperature-stable up to a temperature of at least 450° C., preferably up to a temperature of at least 500° C. “Temperature-stable” in this context means that the material of the heating vessel does not exhibit any irreversible material damage, i.e. for example material fractures, at such temperatures. In particular, the heating vessel can be formed with a metal, for example aluminium, a non-metal or a glass. The dirty liquid is a liquid which may be soiled and hence contaminated by foreign particles and/or foreign matter. If the dirty liquid is for example dirty water, the dirty water may be waste water or unclean drinking-water.

According to at least one embodiment, the purification device comprises at least one inlet valve for feeding the dirty liquid into a heating chamber of the heating vessel. The heating chamber is formed as a cavity within the heating vessel which is delimited to the outside by a vessel wall of the heating vessel. The inlet valve may in particular be in the form of a flap, which is arranged on the heating vessel so that it can be opened and closed according to whether dirty liquid is to be fed into the heating chamber or not.

According to at least one embodiment, the purification device comprises at least one outlet valve for discharging the dirty liquid from the heating vessel. In such case, the outlet valve is arranged on the heating vessel so that it can be opened and closed. Preferably the inlet valve and the outlet valve are interconnected in operation of the purification device via the valve control unit in such a way that at most one of the two valves is opened and the other valve in each case is closed.

According to at least one embodiment, the purification device comprises at least one gas overpressure valve for discharging gas located in the heating chamber. If dirty liquid is fed into the heating vessel via the inlet valve and is heated, a gaseous steam forms over the dirty liquid within the heating chamber, which steam can be let out from the heating chamber via the gas overpressure valve and thus can escape from the heating chamber.

According to at least one embodiment, the purification device comprises at least one valve control unit for mechanically controlling the valves, the inlet valve, the outlet valve and the gas overpressure valve being mechanically engaged with each other via the valve control unit such that in operation of the heating vessel, during heating of the dirty liquid, up to a limit gas pressure which can be pre-set by the valve control unit of at least one atmosphere within the heating chamber, the inlet valve can be operated in an open position and the outlet valve and the gas overpressure valve can be operated in a closed position in each case by the valve control unit.

In doing so, once the limit gas pressure has been exceeded, the inlet valve can be closed by the valve control unit and the outlet valve and/or the gas overpressure valve can be opened by the valve control unit, and if the gas pressure, having exceeded the limit gas pressure, then falls below said limit pressure, the outlet valve and/or the gas overpressure valve can be closed again by the valve control unit and the inlet valve can be opened again. “Mechanical control” in this context means that the movement of the valves is carried out exclusively via mechanical elements of the valve control unit. This means in particular that electronic switching elements for moving the valves are dispensed with. The valve control unit is therefore free from electrical components. In particular, electrical control of the valves is completely dispensed with. Furthermore, the purification device may however additionally have pressure sensors and electric and/or pneumatic motors. Such elements do not, however, intervene in the valve control.

According to at least one embodiment, the purification device for purifying and heating dirty liquid comprises a heating vessel for heating the dirty liquid, at least one inlet valve for feeding the dirty liquid into a heating chamber of the heating vessel, at least one outlet valve for discharging the dirty liquid from the heating vessel, as well as at least one gas overpressure valve for discharging gas located in the heating chamber. Furthermore, the purification device comprises at least one valve control unit for mechanically controlling the valves, the inlet valve, the outlet valve and the gas overpressure valve being mechanically engaged with each other via the valve control unit such that in operation of the heating vessel, during heating of the dirty liquid, up to a limit gas pressure which can be pre-set by the valve control unit of at least one atmosphere within the heating chamber, the inlet valve can be operated in an open position and the outlet valve and the gas overpressure valve can be operated in a closed position in each case by the valve control unit. Once the limit gas pressure has been exceeded, the inlet valve can be closed by the valve control unit and the outlet valve and/or the gas overpressure valve can be opened by the valve control unit. If the gas pressure, having exceeded the limit gas pressure, then falls below said limit pressure, the outlet valve and/or the gas overpressure valve can be closed again by the valve control unit and the inlet valve can be opened again.

According to at least one embodiment, the valves are in each case mounted rotatably in a pivot point on openings in the heating vessel which are provided for the valves. The valve control unit is formed with a first rod device and a second rod device, which are guided in each case along an outer wall of the heating vessel. The first rod device connects the inlet valve to the gas overpressure valve mechanically securely, the second rod device connecting the gas overpressure valve and the outlet valve together mechanically securely. The valves are therefore engaged mechanically with each other in each case via the rod devices. Displacement for example of the first rod device brings about, firstly, opening of the inlet valve and at the same time closing of the gas overpressure valve, and vice versa. In this respect, the gas overpressure valve and the inlet valve can be mechanically locked with each other. In addition, the first rod device may be set up such that in no position of the first rod device both the inlet valve and the gas overpressure valve are opened. Also the gas overpressure valve and the outlet valve may in each case be engaged and/or be locked mechanically with each other via the second rod device such that upon a movement of the rod device either the gas overpressure valve and the outlet valve are jointly closed or both valves are opened. Such an arrangement and configuration of the valve control unit, formed by the two rod devices, therefore results in particularly simple mechanical interconnection of the valves, without electronic and/or pneumatic elements which are matched to one another being used for coordinating movement of the respective valves.

According to at least one embodiment, the second rod device is arranged rotatably about a pivot point on a rotary holding means, a first lever end of the second rod device being connected mechanically securely to a first lever end of the gas overpressure valve, and a second lever end of the second rod device being connected mechanically securely to a second lever end of the outlet valve, with both the gas overpressure valve and the outlet valve being able to be opened by a lever movement of the second rod device. By means of such a rotary holding means, a mechanical rotation mechanism is realised which, apart from pivot hinges integrated in the rotary holding means, requires no further mechanically movable parts, as a result of which mechanical locking of the gas overpressure valve with the outlet valve is realised in a particularly simple, compact and stably-operating manner.

According to at least one embodiment, the first rod device is connected mechanically securely to the gas overpressure valve at a second lever end of said valve, located opposite the first lever end of the gas overpressure valve. If the gas overpressure valve is realised for example in the form of a closable flap, preferably the two rod devices are fastened to the gas overpressure valve at in each case opposing ends of said valve. Due to the fact that the gas overpressure valve has a fulcrum which is arranged between these ends of the gas overpressure valve, the gas overpressure valve acts as a mechanical lever. This results in the two rod devices being engaged with each other via the gas overpressure valve.

According to at least one embodiment, an optical heating system for heating the dirty liquid in the heating chamber is provided, with electromagnetic radiation being able to be directed in a pre-settable manner at the heating vessel via the optical heating system. “Optical” heating system in this context means that this heating system is formed by means of optical elements and at least one radiation source which emits electromagnetic radiation. For this, in operation of the purification device the optical heating system directs electromagnetic radiation directly or indirectly onto the heating vessel, as a result of which, for example owing to the heat-conduction properties of the material of the heating vessel, the dirty liquid is likewise heated within the heating vessel. An optical heating system of this type represents a particularly simple and inexpensive solution for heating, by means of which at the same time an energy transfer and an energy transmission from the optical heating system to the heating vessel is particularly energy-efficient, that is to say loss-free.

According to at least one embodiment, the electromagnetic radiation which can be emitted by the optical heating system can be introduced into the heating chamber via at least one radiation-previous passage region which is formed in a vessel wall of the heating vessel. “Radiation-previous” in this context means that the passage region is at least 80%, preferably more than 90%, pervious to impinging electronic radiation. In particular, the passage region may be formed with a radiation-transparent glass which is arranged in an opening in the vessel wall of the heating vessel and is inserted therein. If now the heating vessel is formed for example with a radiation-impervious material, electromagnetic radiation for heating the dirty liquid can be introduced directly into the heating chamber via the passage region in a particularly efficient and targeted manner.

According to at least one embodiment, the optical heating system comprises at least one radiation-reflecting mirror, which is arranged within the heating chamber on an inner wall of the heating vessel. Preferably the mirror is arranged and/or configured such that, once the electromagnetic radiation introduced into the heating chamber has impinged on it, it is reflected back at least partially by the mirror onto further points of the inner wall which differ from the passage region. In particular, focal points or points of particularly high energy concentration and/or heat concentration can form within the heating chamber due to the one, or the plurality of, mirror(s). Alternatively, the mirrors may be configured such that electromagnetic radiation introduced via the passage region is distributed particularly homogeneously and uniformly within the heating chamber, so that the dirty water can be heated uniformly.

According to at least one embodiment, at least one optical beam splitter is arranged in a main beam direction of the optical heating system between the optical heating system and the heating vessel, which splitter first of all separates electromagnetic radiation emitted by the optical heating system into at least two partial beams, and these can then be directed onto different points on the heating vessel in a pre-settable manner by means of optical deflection elements. A beam splitter of this type therefore permits, in a particularly simple manner, partial deflection of the electromagnetic radiation towards different points of the heating vessel which are located opposite one another for example in the main beam direction. Since heating of the dirty liquid is initially greatest in the vicinity of the points of incidence of the electromagnetic radiation on the heating vessel, owing to the temperature differences during heating a liquid circulation is yielded within the dirty liquid which makes a heat transfer to cooler regions of the dirty liquid particularly simple and efficient.

According to at least one embodiment, at least one diverging lens is arranged in a main beam direction of the optical heating system between the optical heating system and the heating vessel. By means of the diverging lens, the cross-sectional area of a beam cross-section of the electromagnetic radiation can be expanded and can thus strike the heating vessel two-dimensionally. Such reshaping of the heating beam by the diverging lens which is of as large an area as possible results in heating of the vessel wall and thus likewise of the dirty liquid which is of as wide an area and as homogeneous as possible.

According to at least one embodiment, the purification device comprises at least one electrical heating system for heating the dirty liquid in the heating chamber. The electrical heating system comprises at least one conductor arrangement, with electric current being able to be passed through the conductor arrangement. If the conductor arrangement is connected to a power source, the current flowing through the conductor arrangement causes heating of the conductor arrangement itself This heat is then transmitted by the conductor arrangement to the dirty liquid. Such an arrangement consisting of heating system and heating vessel is particularly space-saving, since the electrical heating system is guided at least partially through the heating vessel or is fastened directly thereto. Furthermore, such an electrical heating system forms an inexpensive alternative to the optical heating system already explained above. In such case, the purification device may however also comprise both the optical heating system and the electrical heating system. Such a solution offers the possibility of utilising the advantages, which are for example complementary in each case, of the respective heating systems at the same time in order to effect heating of the dirty liquid in a particularly rapid and hence time-saving manner.

According to at least one embodiment, the conductor arrangement is formed with at least one coil which is guided within the heating chamber or along an inner and/or outer wall of the heating vessel. Such a configuration of the conductor arrangement in the form of the coil, owing to the inherent inductance in the coil, provides the possibility of transmitting the heat generated by the coil to the dirty liquid as uniformly as possible within the heating chamber.

According to at least one embodiment, the conductor arrangement is guided along lateral edges of the heating vessel. In this case too, the heat is transmitted as uniformly as possible by the conductor arrangement, which is supplied with current, to the dirty liquid via the vessel wall. The conductor arrangement on the lateral edges may furthermore heat the dirty liquid uniformly and homogeneously as efficiently as possible starting from the lateral edges up to the interior of the heating chamber.

According to at least one embodiment, the heating vessel has a cylindrical, cubic or pyramidal basic form. According to the named basic forms, particularly efficient, for example uniform, heating of the dirty liquid can be set individually by means of the geometric basic nature of the heating vessel itself. For example, the pyramidal basic form of the heating vessel, once the electromagnetic radiation has been introduced via the passage opening, owing to the reflection properties of the inner wall of the heating vessel and/or owing to mirrors arranged on the inner wall, permits a particularly simple reflecting-back function within the heating chamber, since owing to the lateral faces of this pyramidal basic form which are angled obliquely to the main beam direction of the optical heating system any electromagnetic radiation is initially directed away from the passage opening in the direction of a base surface of the heating vessel. Such obliquely angled lateral faces can therefore result in particularly rapid, efficient distribution of the electromagnetic radiation within the heating chamber.

According to at least one embodiment, a gaseous pure steam obtained from the dirty liquid can be discharged from a gas opening of the heating vessel and can be introduced into a cleaning unit, the pure steam being able to be heated to at least 300° C. in the cleaning unit, and then the pure steam being able to be condensed along a cooling section. By means of such an arrangement, a particularly simple, inexpensive way of directly recovering a clean liquid from the dirty liquid heated in the heating vessel can be obtained. In addition, the cleaning unit advantageously ensures that for example pharmaceutical byproducts and/or other impurities still located in the pure steam which is discharged from the heating vessel are heated to such an extent that they are destroyed by the heating to at least 300° C. That is to say that the condensed pure steam is also free from such additional impurities.

Furthermore, a method for producing a clean liquid from a dirty liquid is devised. That is to say that the features disclosed for the purification device which is described here are also disclosed for the method which is described here, and vice versa.

In a first step, a purification device according to at least one of the preceding embodiments is provided.

In a next step, the purification device is connected to a liquid circuit.

In a further step, the purification device is put into operation. By means of the method for producing a clean liquid which is described here, it is therefore illustrated in a particularly simple and efficient manner how a clean liquid can be produced from a dirty liquid inexpensively and promptly.

Below, the purification device which is described here as well as the method which is described here will be explained in greater detail using embodiments and the associated figures.

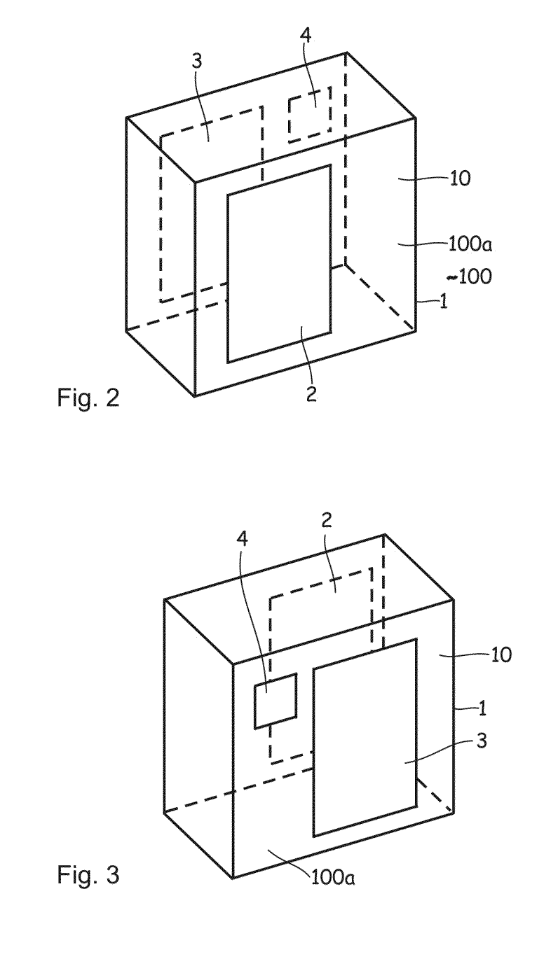

FIGS. 2 and 3 show a basic construction of the purification device which is described here in different perspective views.

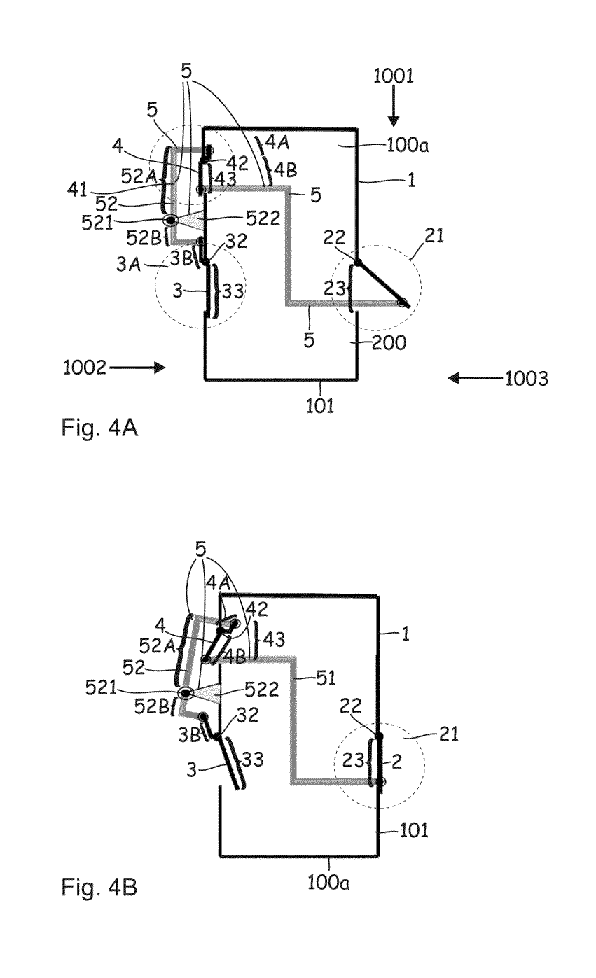

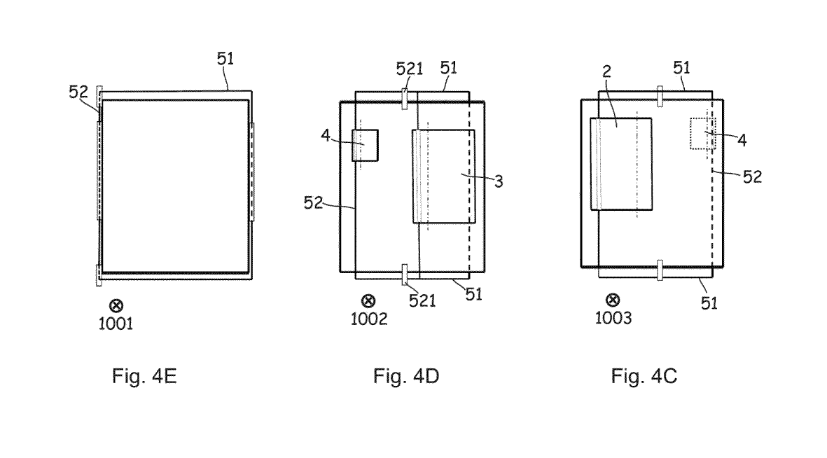

FIGS. 4A to 4E show the purification device illustrated in FIGS. 1 and 2 in different valve positions in a top view or side view in each case.

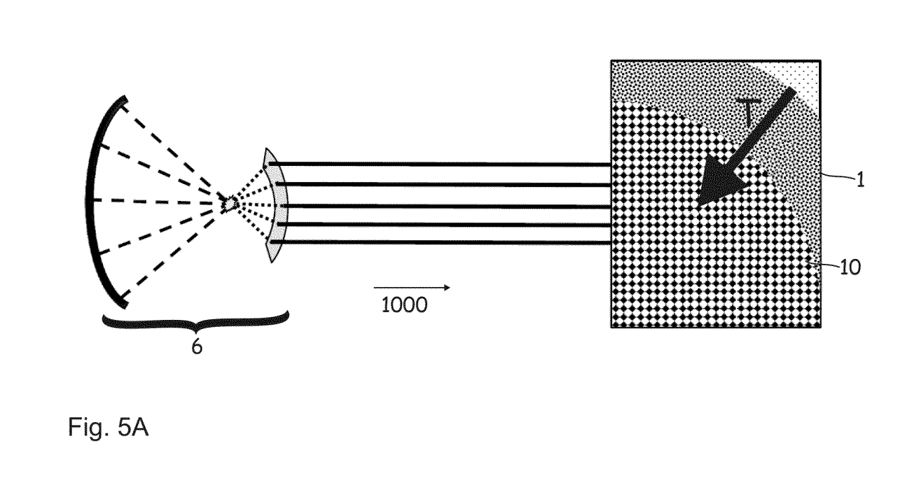

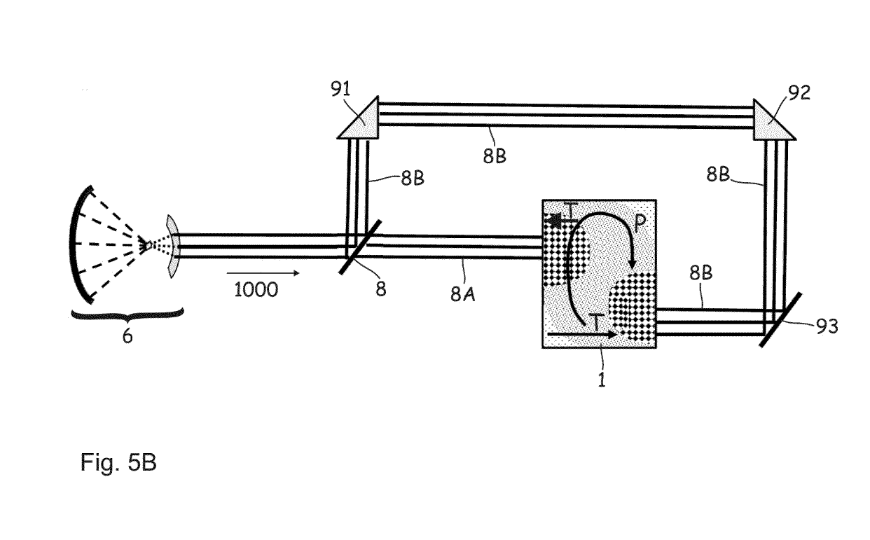

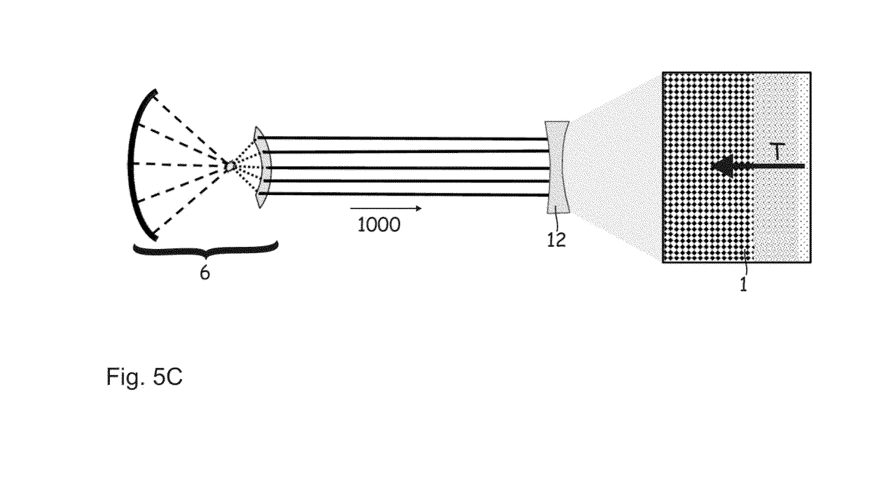

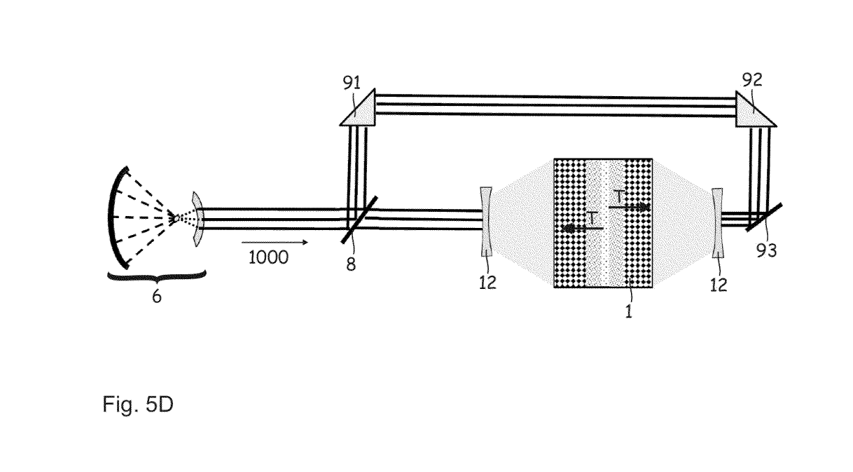

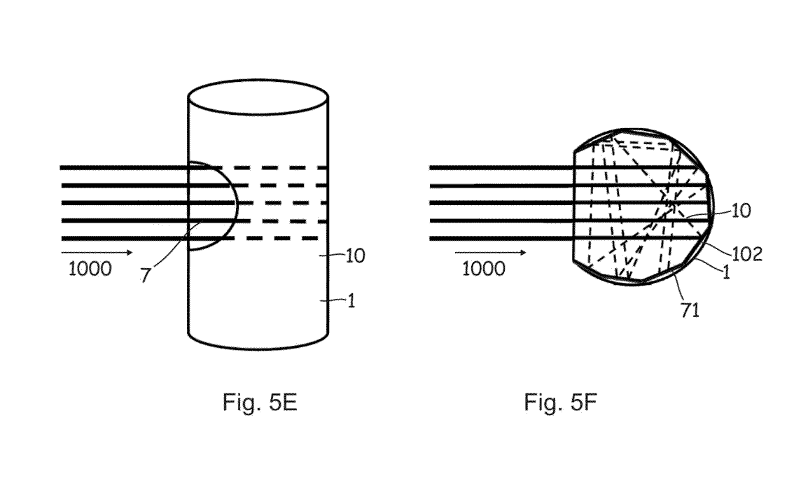

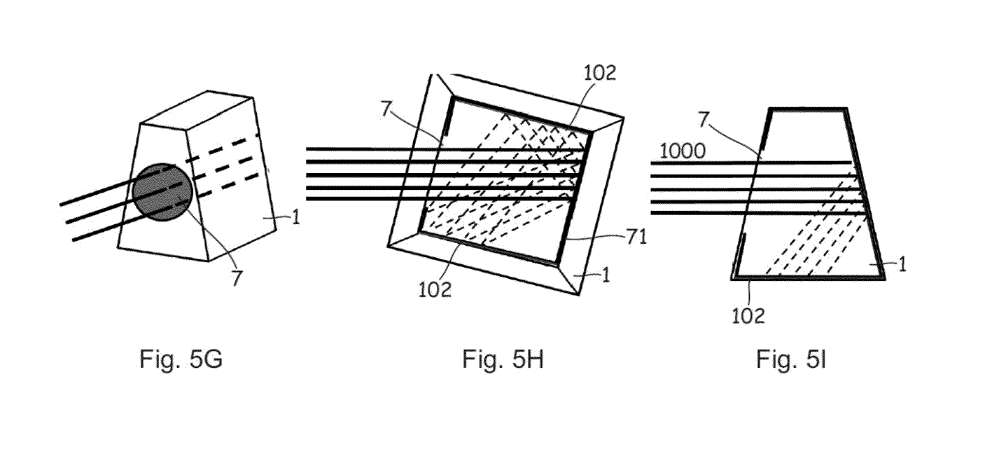

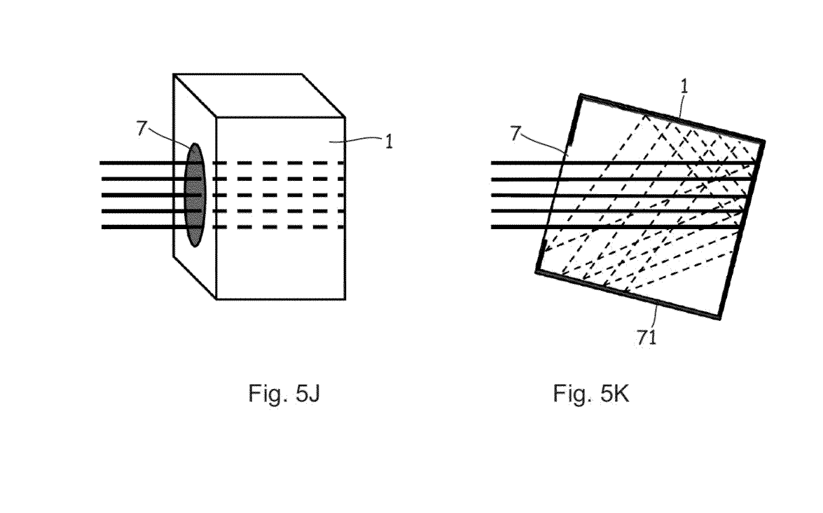

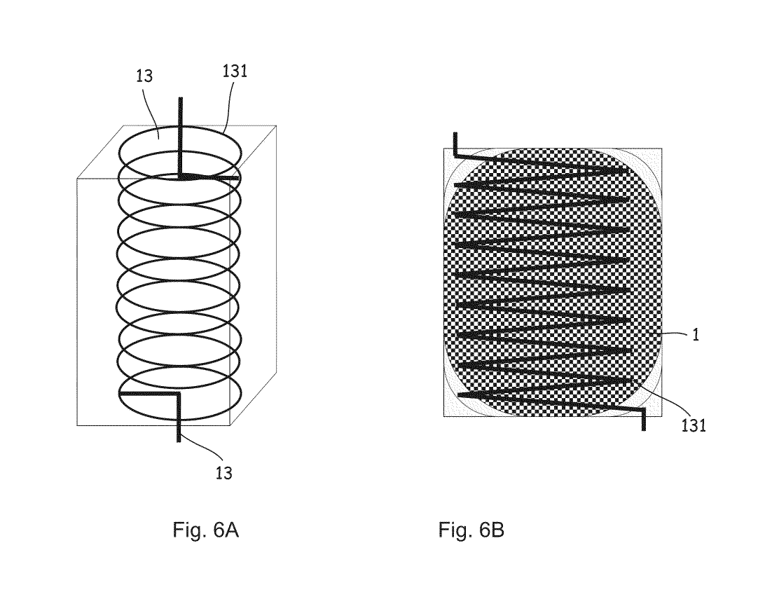

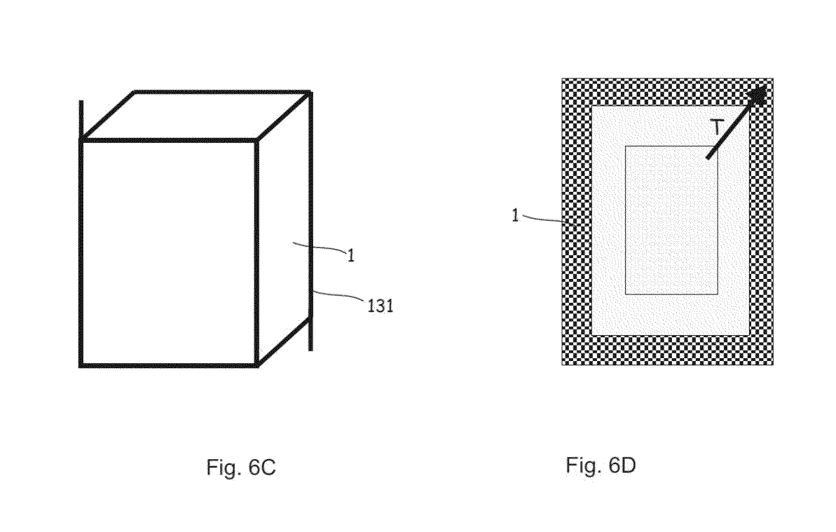

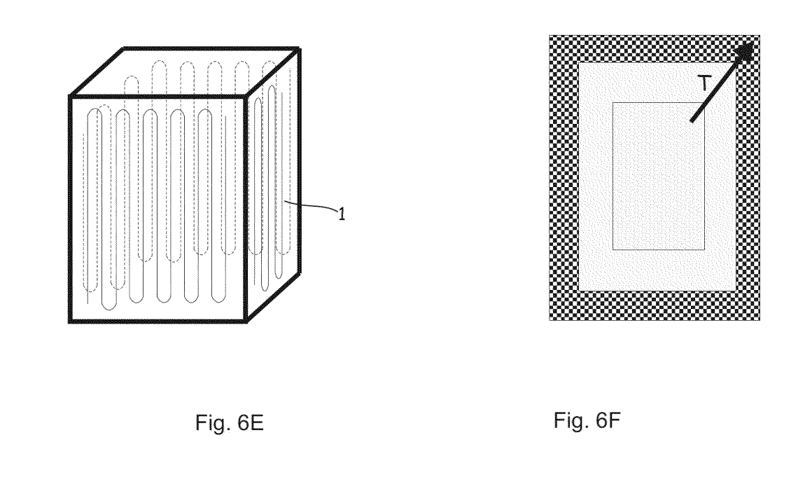

FIGS. 5A to 6F show further embodiments of the purification device which is described here in diagrammatic side views.

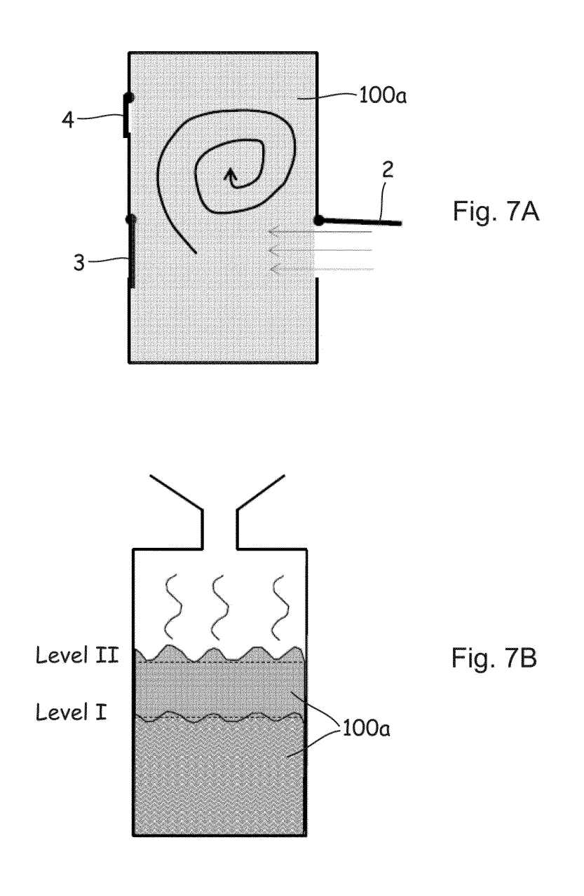

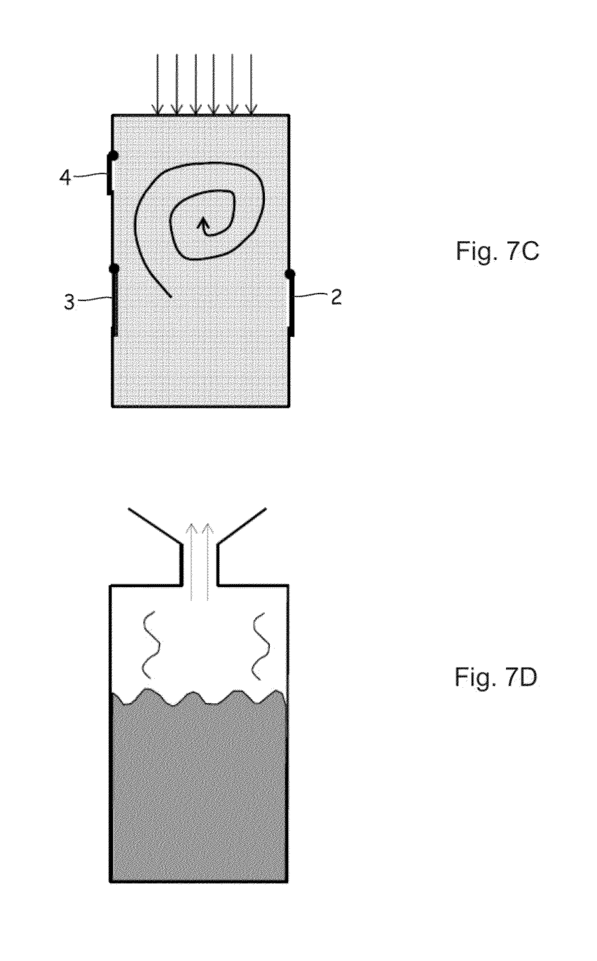

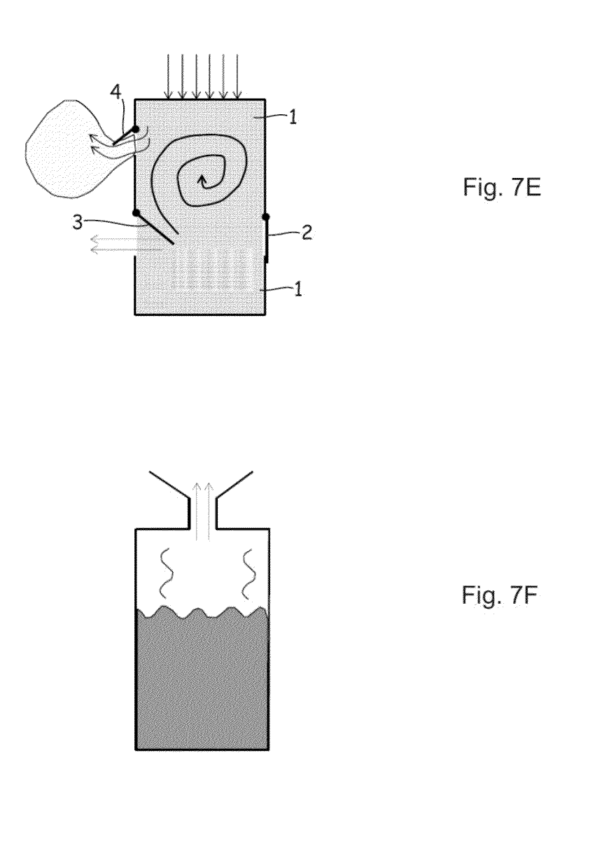

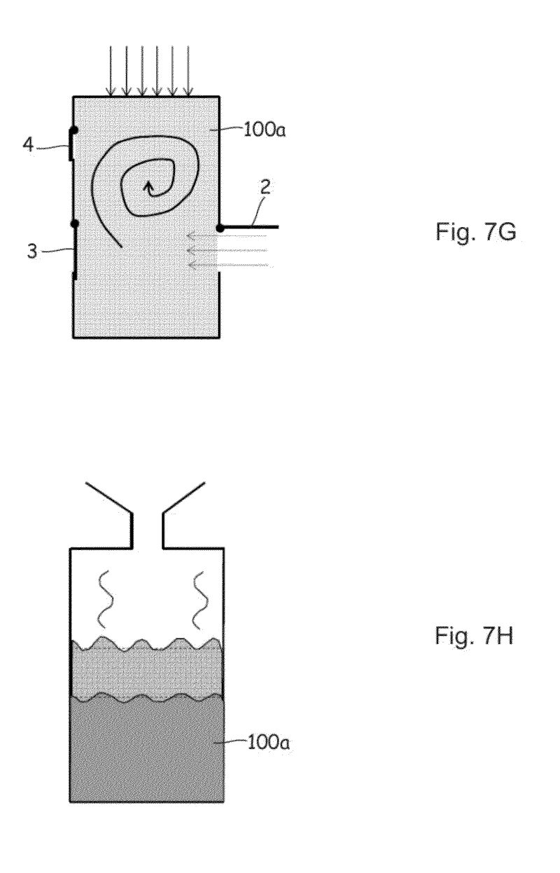

FIGS. 7A to 7H show the purification device shown in FIGS. 2 to 4E during its operation.

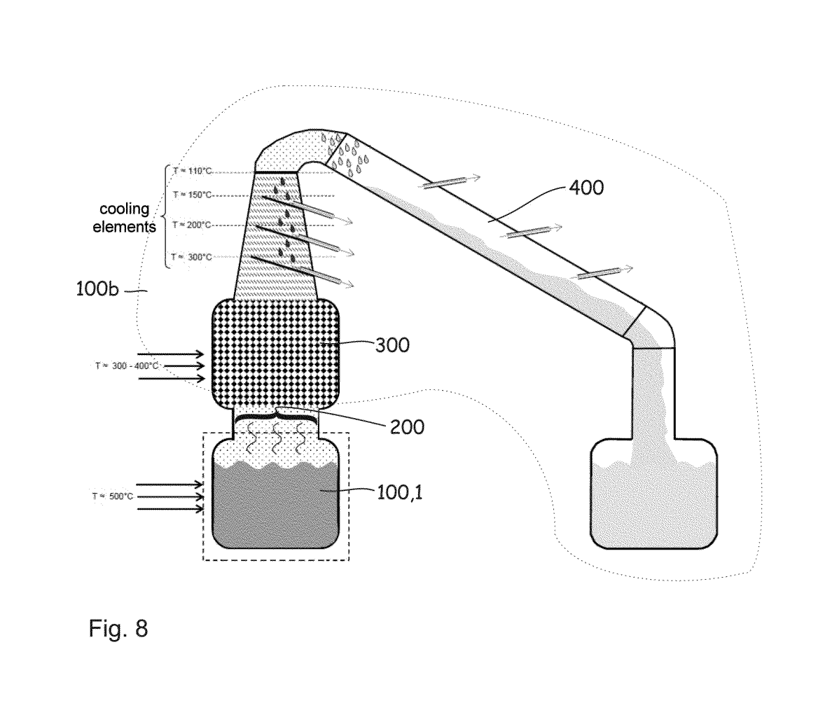

FIG. 8 shows a further embodiment of a purification device which is described here in a diagrammatic side view.

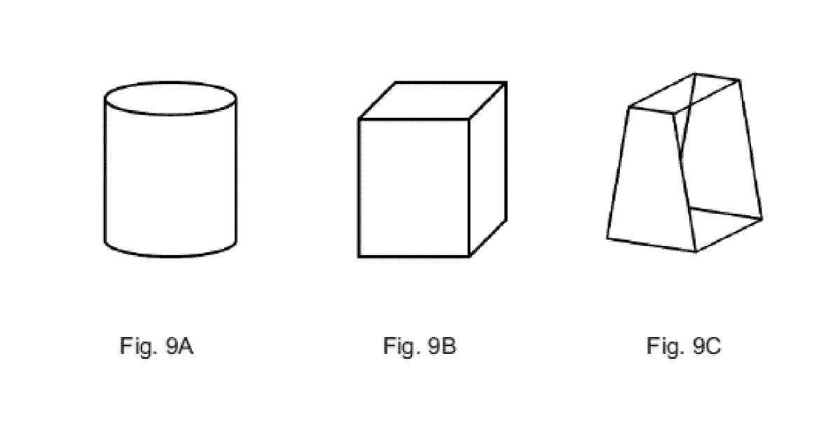

FIGS. 9A to 9C show different forms of a heating vessel which is described here in diagrammatic side views.

In the embodiments and in the figures, components which are identical or have an identical effect are provided in each case with the same reference numerals. The elements illustrated should not be regarded as being to scale; rather, individual elements may be shown exaggeratedly large for better understanding.

In FIG. 2, a purification device 100 which is described here for the purification of dirty liquid 100a (not shown here) is indicated with reference to a diagrammatic perspective view. The purification device 100 comprises a heating vessel 1 for heating the dirty liquid 100a. In this case, the dirty liquid 100a can be arranged in a heating chamber 10 of the heating vessel 1. In addition, the purification device 100 comprises an inlet valve 2 for feeding the dirty liquid 100a, an outlet valve 3 for discharging the dirty liquid 100a from the heating vessel 1 and a gas overpressure valve 4 for discharging gas which is located in the heating chamber 10. The heating vessel 1 is embodied in the form of a cuboid, with both the outlet valve 3 and the gas overpressure valve 4 being arranged on one longitudinal face, and the inlet valve 2 being arranged on a second longitudinal face of the cuboid which is located opposite this longitudinal face. In other words, the inlet valve 2 on one side and on the other side the outlet valve 3 and the gas overpressure valve 4 are located opposite each other.

FIG. 3 shows the purification device shown in FIG. 2 in a further diagrammatic perspective view.

In FIG. 4A, the purification device 100 shown in FIGS. 2 and 3 is shown in a diagrammatic top view. It can be seen that the valves 2, 3, 4 in each case are fastened and mounted in a pivot point 22, 32, 42 rotatably on openings 23, 33, 43 on the heating vessel 10 which are provided for the valves 2, 3, 4. In the present case, the valves 2, 3 and 4 are in the form of closable flaps. Furthermore, it can be seen from FIG. 4A that the purification device 100 comprises a valve control unit 5 for mechanically controlling the valves 2, 3, 4, the valve control unit 5 being formed with a first rod device 51 and a second rod device 52 which are guided in each case along an outer wall 101 of the heating vessel 1. The first rod device 51 connects the inlet valve 2 to the gas overpressure valve 4 mechanically securely with its two ends. The second rod device 52 connects the gas overpressure valve 4 and the outlet valve 3 together mechanically securely with its two ends. In the valve configuration shown in FIG. 4A, the inlet valve 2 is illustrated in an open position 21 for example before the dirty liquid 100a is heated. In other words, in this valve configuration dirty liquid 100a can be introduced into the heating chamber 10. This results directly in the gas overpressure valve 4 itself being or becoming closed, during filling, via the first rod device 51, which on the other hand in turn is arranged with the second end on a second lever end 4B which is located opposite a first lever end 4A of the gas overpressure valve 4. In other words, the inlet valve 2 and the gas overpressure valve 4 are locked together via the first rod device 51 such that in no operating state are both the inlet valve 2 and the gas overpressure valve 4 opened. In this respect, the gas overpressure valve 4 and the outlet valve 3 are in each case in closed positions 31, 41.

Furthermore, it can be seen from FIG. 4A that the second rod device 52 is arranged rotatably about a pivot point 521 on a rotary holding means 522, a first lever end 52A of the second rod device 52 being connected mechanically securely to the first lever end 4A of the gas overpressure valve 4, and a second lever end 52B of the second rod device 52 being connected mechanically securely to a second lever end 3B of the outlet valve 3. In this case, in FIG. 4A the rod device 52 is in equilibrium, i.e. non-deflected, so that both the outlet valve 3 and the gas overpressure valve 4 are closed. The valve configuration illustrated in FIG. 4A can therefore be regarded as a “filling phase” of the heating vessel 1.

FIG. 4B shows a valve configuration of the valves 2, 3, 4 which differs from FIG. 4A. In contrast to FIG. 4A, now the inlet valve 2 is closed by means of a movement of the first rod device 51 in the direction towards the outlet valve 3 and/or the gas overpressure valve 4, whereas the gas overpressure valve 4 is opened via the lever force exerted by the first rod device 51 on the gas overpressure valve 4. Due to the fact that the second rod device 52 is connected in a lever-like manner to the first lever end 4A of the gas overpressure valve 4 on one hand and to the first lever end 3A of the outlet valve on the other hand via the pivot point 521, opening of the gas overpressure valve 4 likewise brings about opening of the outlet valve 3. In this respect, both the rod devices 51, 52 and the inlet valve 2 and the gas overpressure valve 4 are mechanically connected together and/or locked via the movement of the gas overpressure valve 4.

In FIGS. 4C to 4E, the purification device 100 shown in the aforementioned figures is shown in each case from a direction 1001, 1002 and 1003 (see also FIG. 4A), from which both the valves 2, 3, 4 and the rod devices 51, 52 which are guided along the outer surface 101 can be seen particularly clearly. In addition, it becomes clear that in the present embodiment the gas overpressure valve 4 is connected by two arms to the inlet valve 2 via the first rod device 51 (see in particular FIG. 4E).

In FIG. 5A it is shown in a diagrammatic side view how, in contrast to the purification device 100 of FIGS. 2 to 4E, this device additionally comprises an optical heating system 6 for heating the dirty liquid 100a in the heating chamber 10. In this case, the optical heating system 6 is formed with a point light source which directs electromagnetic radiation onto the heating vessel 1 via a parabolic mirror and a converging lens along a main beam direction 1000. Such a system is particularly simple of construction and inexpensive to produce. Furthermore, the energy transfer starting from the point light source towards the heating vessel 1 is as direct as possible. In this case, the direction of the arrow T represents a direction of increasing temperature in the dirty liquid 100a.

In FIG. 5B, in contrast to in FIG. 5A, it is shown how the purification device 100 additionally has an optical beam splitter 8. The optical beam splitter 8 is arranged in the main beam direction 1000 between the optical heating system 6 and the heating vessel 1. In this case, the optical beam splitter 8 splits the incident electromagnetic radiation into two partial beams 8A and 8B, the partial beam 8A passing in an undeflected manner through the beam splitter 8 and directly striking the heating vessel 1 in a pre-settable manner, whereas the partial beam 8B strikes the heating vessel 1 via deviating prisms 91, 92 as well as a deflecting mirror 93 onto an outer surface of said vessel which is located on the opposite side from the optical heating system 6. Since now initially the heating of the dirty liquid 100a in the heating vessel 1 is greatest in the vicinity of the two regions of impingement of the electromagnetic radiation, the temperature differences in the heating chamber 10 (illustrated by the arrows T) advantageously generate a particularly effective heat circulation and/or liquid circulation within the heating chamber 10, as a result of which a particularly efficient energy transfer and hence heat exchange within the dirty liquid 100a occurs.

In FIG. 5C, in contrast to FIG. 5B, a diverging lens 12 is arranged instead of the optical beam splitter 8, which lens expands the radiation cross-section of the electromagnetic radiation which extends parallel to the main beam direction 1000, so that as large as possible an area of the heating vessel 1 is heated by the impinging electromagnetic radiation. Such a configuration of the purification device 100 comprising the diverging lens 12 is particularly simple in its construction and effective with regard to a direct energy transfer.

In FIG. 5D, a further embodiment, a purification device 100 which is described here is shown in a diagrammatic side view. In contrast to the embodiment of FIG. 5B, the diverging lens 12 is arranged in the main beam direction 1000 between the optical beam splitter 8 and the heating vessel 1. Additionally, a further diverging lens 12 is arranged in the main beam direction 1000 between the heating vessel 1 and the mirror 93, so that the heating vessel 1 is irradiated with electromagnetic radiation over as large an area as possible on both sides, as a result of which still a more efficient and homogeneous heating of the dirty liquid 100a is realised.

In FIGS. 5E and 5F, a further embodiment of a purification device 100 which is described here is shown in which the heating vessel 1 has a cylindrical basic form. In addition, a radiation-pervious passage region 7 is formed in a vessel wall 11, which region in the present case is formed with a radiation-pervious glass. It can be seen that the electromagnetic radiation, for example generated by one of the optical heating systems 6 already described above, is guided through the radiation-pervious passage region 7 into the heating chamber 10. Such a passage region 7 therefore permits particularly targeted heating of the dirty liquid 100a.

In FIG. 5F, the purification device 100 shown in FIG. 5E is shown in a diagrammatic top view. It can be seen that the electromagnetic radiation introduced into the heating chamber 10 via the passage opening 7 strikes radiation-reflecting mirrors 71 arranged on an inner wall 102 of the heating vessel 1. The mirrors 71 may for example be suitable for multiple reflection and reflect the incident electromagnetic radiation at points which are at least partially different from the passage region 7. In particular, the radiation-reflecting mirrors 71 may be configured and/or arranged such that the electromagnetic radiation impinging upon them is not reflected out of the heating chamber 10 again via the radiation-pervious passage region 7. By means of such an arrangement of the radiation-reflecting mirrors 71, a particularly homogeneous radiation and/or energy distribution within the heating chamber 10 is provided, as a result of which the dirty liquid 100a can be heated as uniformly as possible and at the same time rapidly. Furthermore, the cylindrical form is advantageous in that it distributes pressures building up within the heating chamber 10 particularly uniformly, that is to say peripherally, so that such a form of the heating vessel 1 is particularly stable to ageing. Furthermore, owing to the peripheral force distribution a wall thickness of the heating vessel 1 can be made particularly thin, which results in a saving of material in the production of the heating vessel 1.

In FIG. 5G, in contrast to FIGS. 5E and 5F, the heating vessel 1 is configured in a pyramidal basic form. In the present case, radiation-reflecting mirrors 71 are again arranged on the inner wall 102. For example, for as efficient as possible a uniform distribution of the electromagnetic radiation within the heating chamber 10, the heating vessel 1 can be for example rotated independently of the optical heating system. Due to such a rotation, the electromagnetic radiation, which even during the rotation always passes at least partially through the passage region 7, strikes the mirrors 71 and/or the dirty liquid at various points within the heating chamber 10, so that consequently electromagnetic radiation can strike as many points of the inner wall 102 as possible.

FIG. 5H shows the purification device 100 shown in FIG. 5G in a diagrammatic top view.

FIG. 5I further shows that the electromagnetic radiation which is incident in parallel, due to the lateral faces of the pyramidal basic form of the heating vessel 1 which run obliquely to the main beam direction 1000, automatically reflected electromagnetic radiation in the direction of a base surface of the heating vessel 1. In this respect, “three-dimensional” internal reflections within the heating chamber 10 are realised in a particularly simple manner. A configuration of this type is furthermore simple to produce and inexpensive in production.

In FIG. 5J, the purification device 100 is shown in a further diagrammatic perspective view, in which, in contrast to the purification device 100 according to FIGS. 5G to 5I, the heating vessel 1 has a cubic form. Such a cubic configuration of the heating vessel 1 is also particularly inexpensive and simple in construction.

A further embodiment of a purification device 100 which is described here can be inferred from FIG. 6A in a further, diagrammatic perspective view. In contrast to the purification device 100 for example of FIGS. 5A to 5K, the purification device 100 of FIG. 6A has an electrical heating system 13 for heating the dirty liquid 100a in the heating chamber 10 instead of the optical heating system 6. In this case, the electrical heating system 13 is formed with a conductor arrangement 131, with electric current being able to be passed through the conductor arrangement 131. In the present case, the conductor arrangement 131 is formed with a coil which runs within and through the heating chamber 10. After the coil has been supplied with a current, the coil heats up due to the inductance thereof, the generated heat then being given off to the dirty liquid 100a. Such heating is therefore particularly homogeneous and furthermore, due to dispensing with an optical heating system because of the fact that the electrical heating system 13 “is integrated” into the heating vessel, is particularly space-saving.

In FIG. 6B, a heat distribution in operation of the purification device 100 shown in FIG. 6A is shown diagrammatically. It can be seen that the heat is distributed particularly efficiently and uniformly over the entire heating chamber 10. In principle, the electrical heating system 13 offers a particularly stably-operating and low-risk possibility of heating.

In FIG. 6C, a further embodiment of a purification device 100 which is described here is shown in a diagrammatic perspective view, in which, in contrast to FIGS. 6A and 6B, the conductor arrangement 131 is guided along lateral edges of the heating vessel 1 instead of along the coil. Starting from the lateral edges, when the conductor arrangement 131 is supplied with electric current the heat is transmitted uniformly from the conductor arrangement 131 to the dirty liquid 100a (temperature increasing in the direction of the arrow T, see FIG. 6D). Such an arrangement is also particularly space-saving and energy-efficient.

In FIG. 6E, a further embodiment of a purification device 100 which is described here is shown in a diagrammatic perspective view, in which, in contrast to the embodiment of the purification device 100 according to FIGS. 6A to 6D, the conductor arrangement 131 is guided along lateral faces of the cubic heating vessel 1.

It can readily be seen in FIG. 6F that in such case, starting from the lateral faces, the thermal energy is transmitted two-dimensionally to the dirty liquid 100a.

FIG. 7A shows a principle of operation of the purification device 100 shown in FIGS. 2 to 4E. In particular, it can be seen from FIG. 7A that the inlet valve 2 is initially opened to fill the heating chamber 10 with the dirty liquid 100a, while the outlet valve 3 and the gas overpressure valve 4 are closed.

A side view is shown in FIG. 7B. In this case, the inlet valve 2 remains open until a limit pressure of one atmosphere occurs within the heating chamber 10. If this limit pressure is exceeded, the gas overpressure valve 4 opens to reduce the pressure, and the inlet valve 2 closes at the same time. In other words, the heating vessel 1 is filled to a filling level from a Level I to a Level II until the limit pressure occurs.

In FIGS. 7C (top view) and 7D (side view) it is shown how, in a next step, all the valves are or become closed on the heating vessel 1 once the limit gas pressure has been formed. During the heating, the inlet valve 2, the outlet valve 3 and the gas overpressure valve 4 are closed.

In FIGS. 7E (top view) and 7F it is shown that upon further heating of the dirty liquid 100a the pressure within the heating vessel 1 increases to above one atmosphere, which causes the valve control unit 5 to keep the inlet valve 2 closed and to open both the outlet valve 3 and the gas overpressure valve 4 in order to reduce the pressure. If now the gas pressure within the heating vessel 1 has then dropped to below one atmosphere again, the valves 3 and 4 are closed again by the valve control unit 5. At the same time, in order to increase the pressure, dirty liquid 100a is again introduced into the heating vessel 1 (see FIGS. 7G and 7H) by opening the inlet valve 2 until the gas pressure again exceeds one atmosphere. In other words, the gas pressure fluctuates about the limit gas pressure of one atmosphere within the heating vessel 1 during operation thereof.

In FIG. 8, a further embodiment of the purification device 100 which is described here is shown in a diagrammatic perspective side view, in which a cleaning unit 300 is connected to a gas opening 200 of the heating vessel 1, through which the pure steam formed within the heating vessel 1 can be introduced. The pure steam is heated to a temperature of at least 300° C. within the cleaning unit 300, as a result of which any polluting constituents which may still be located within the pure steam, for example pharmaceutical byproducts, are destroyed and/or burned. Thereafter, the pure steam can condense into a purified liquid after it has passed through the cleaning unit 300 and a cooling section 400. In FIG. 8, purified water is obtained which is at a temperature of for example at least 70° C. and at most 90° C. In this respect, the purified water can be used immediately, that is to say without further cooling steps, for other purposes, for example for further treatment or for further bottling. In other words, the heating vessel together with the cleaning unit 300 and the cooling section 400 form a liquid circuit 100b. Such a purification device 100 is therefore particularly compact and efficient in construction, which makes it possible to produce the purification device 100 particularly inexpensively.

FIGS. 9A to 9C show in diagrammatic side views a heating vessel 1 in cylindrical form (see FIG. 9A), cubic form (see FIG. 9B) as well as in pyramidal form (see FIG. 9C), the individual forms having the advantages already described above in each case.

The invention is not restricted by the description with reference to the embodiments. Rather, the invention comprises every novel feature and every combination of features, which in particular contains every combination of features in the patent claims, even if this feature or this combination itself is not explicitly stated in the patent claims or in the embodiments.

### LIST OF REFERENCE NUMERALS

I Level I

II Level II

1 heating vessel

2 inlet valve

3 outlet valve

3B second lever end

4 gas overpressure valve

4A first lever end

5 valve control unit

6 optical heating system

7 passage region

8 beam splitter

8A partial beam

8B partial beam

10 heating chamber

11 vessel wall

12 diverging lens

13 electrical heating system

21 open position of inlet valve 2

22 pivot point

23 openings

31 closed position of outlet valve 3

32 pivot point

33 openings

41 closed position of gas overpressure valve 4

42 pivot point, first lever end

43 openings, second lever end

51 first rod device

52 second rod device

52A first lever end

52B second lever end

71 radiation-reflecting mirror

91 deviating prism

92 deviating prism

93 deflecting mirror

100 purification device

100a dirty liquid

100b liquid circuit

101 outer wall, outer surface

102 inner wall

131 conductor arrangement

200 limit gas pressure

300 cleaning unit

400 cooling section

521 pivot point

522 rotary holding means

1000 main beam direction

1001 direction

1002 direction

1003 direction

1. Purification device for heating and purifying dirty liquid, comprising a heating vessel for heating the dirty liquid, at least one inlet valve for feeding the dirty liquid into a heating chamber of the heating vessel, at least one outlet valve for discharging the dirty liquid from the heating vessel; at least one gas overpressure valve for discharging gas located in the heating chamber,
wherein at least one valve control unit for mechanically controlling the valves, the inlet valve, the outlet valve and the gas overpressure valve being mechanically engaged with each other via the valve control unit such that in operation of the heating vessel, during heating of the dirty liquid,
up to a limit gas pressure which can be pre-set by the valve control unit of at least one atmosphere within the heating chamber, the inlet valve can be operated in an open position and the outlet valve and the gas overpressure valve can be operated in a closed position in each case by the valve control unit,
once the limit gas pressure (has been exceeded, the inlet valve can be closed by the valve control unit and the outlet valve and/or the gas overpressure valve can be opened by the valve control unit, and
if the gas pressure, having exceeded the limit gas pressure, then falls below said limit pressure, the outlet valve and/or the gas overpressure valve can be closed again by the valve control unit and the inlet valve can be opened again.

2. Purification device according to claim 1,
wherein the valves are in each case mounted rotatably in a pivot point on openings in the heating vessel which are provided for the valves, the valve control unit is formed with a first rod device and a second rod device, which are guided in each case along an outer wall of the heating vessel, and the first rod device connecting the inlet valve to the gas overpressure valve mechanically securely, the second rod device connecting the gas overpressure valve and the outlet valve together mechanically securely.

3. Purification device according to claim 2,
wherein the second rod device is arranged rotatably about a pivot point on a rotary holding means, a first lever end of the second rod device being connected mechanically securely to a first lever end of the gas overpressure valve, and a second lever end of the second rod device to the one second lever end of the outlet valve, with both the gas overpressure valve as well as the outlet valve being able to be opened by a lever movement of the second rod device.

4. Purification device according to claim 2,
wherein the first rod device is connected mechanically securely to the gas overpressure valve at a second lever end of said valve, located opposite the first lever end of the gas overpressure valve.

5. Purification device according to claim 1,
wherein at least one optical heating system for heating the dirty liquid in the heating chamber is provided, with electromagnetic radiation being able to be directed in a pre-settable manner at the heating vessel via the optical heating system.

6. Purification device according to claim 5,
wherein the electromagnetic radiation which can be emitted by the optical heating system can be introduced into the heating chamber via at least one radiation-pervious passage region which is formed in a vessel wall of the heating vessel.

7. Purification device according to claim 5,
wherein the optical heating system comprises at least one radiation-reflecting mirror, which is arranged within the heating chamber on an inner wall of the heating vessel.

8. Purification device according to claim 5,
wherein at least one optical beam splitter is arranged in a main beam direction of the optical heating system between the optical heating system and the heating vessel, which splitter first of all separates electromagnetic radiation emitted by the optical heating system into at least two partial beams, and these can then be directed onto different points on the heating vessel in a pre-settable manner via optical deflection elements.

9. Purification device according to claim 5,
wherein at least one diverging lens is arranged in a main beam direction of the optical heating system between the optical heating system and the heating vessel.

10. Purification device according to claim 1,
wherein at least one electrical heating system for heating the dirty liquid in the heating chamber is provided, comprising at least one conductor arrangement, with electric current being able to be passed through the conductor arrangement.

11. Purification device according to claim 10,
wherein the conductor arrangement is formed with at least one coil which is guided within the heating chamber or along an inner and/or outer wall of the heating vessel.

12. Purification device according to claim 10,
wherein the conductor arrangement is guided along lateral edges of the heating vessel.

13. Purification device according to claim 1,
wherein the heating vessel has a cylindrical, cubic or pyramidal basic form.

14. Purification device according to claim 1,
wherein a gaseous pure steam obtained from the dirty liquid can be discharged from a gas opening of the heating vessel and can be introduced into a cleaning unit, the pure steam being able to be heated to at least 300 degrees Celsius in the cleaning unit, and then the pure steam being able to be condensed along a cooling section.

15. Method for producing a clean liquid from a dirty liquid,
wherein at least the following steps:
providing a purification device according claim 1;
connecting the purification device to a liquid circuit;
subsequent putting into operation of the purification device.
